(19) United States
(12) Patent Application Publication
(10) Pub. No.: US 2004/0178916 A1
(43) Pub. Date: Sep. 16, 2004

(54) Device for gauging level of stored objects

(75) Inventor: Ming Chih Lu, Taipei (TW)

Correspondence Address: BACON & THOMAS, PLLC, 625 SLATERS LANE, FOURTH FLOOR, ALEXANDRIA, VA, 22314

(73) Assignee: Ming-Chih Lu, Taipei (TW)

(21) Appl. No.: 10/701,442

(22) Filed: Nov. 6, 2003

(30) Foreign Application Priority Data
Mar. 12, 2003 (TW) 92105320

(51) Int. Cl. G08B 21/00

(52) U.S. Cl. 340/619

(57) ABSTRACT

A device for gauging levels of stored objects is provided. The safe laser emitters having low power in accordance with a CCD camera are mounted externally of the storage tank so as to gauge the level of a stored object stored inside the storage tank, and at the same time monitor the current condition of such object stored in the storage tank.

### BACKGROUND OF THE INVENTION

1. Field of the Invention

The present invention relates to a device for gauging the level of the stored object, whereby two visible safe laser emitters having low power in accordance with a CCD camera are mounted externally of the storage tank so as to gauge the level of a stored object stored inside the storage tank, and at the same time monitor the current condition of the object stored in the storage tank.

2. Description of the Related Art

For gauging levels of liquids (water, petroleum or chemical solvents) or powder particles (plastic particles, flour or drug powder) stored in storage tanks or containers, the conventional technologies, such as level gauge (R.O.C. Patent Pub. No. 200970) and solder pot level sensor (R.O.C. Patent Pub. No. 333335), provide that level gauges mounted inside storage tanks or containers for gauging levels of stored objects. Further, supersonic measuring means is also provided for calculating reflecting waves so as to acquire levels of stored objects. Both emitters and receptors of supersonic are mounted inside storage tanks. Thus, conventional level gauging devices are those of contact-style gauging devices.

### SUMMARY OF THE INVENTION

In view of the drawbacks caused by conventional gauging devices, gauging devices are often susceptible to corrosion or damage due to the fact that contact-style gauging devices might easily come into contact with toxic or harmful material stored while gauging levels of stored liquids or powder particles, and the electrical devices disposed in the gauging systems are unable to be completely separated from stored objects within storage tanks, thus prone to cause electricity leakage of the gauging devices, electrolytic dissociation or gas explosion,

The object of the present invention is thus to provide a device for gauging levels of stored objects, whereby two visible safe laser emitters having low power in accordance with a CCD (Charge Coupled Device) camera are mounted externally of the storage tank so as to gauge the level of liquids or powder particles stored inside the storage tank, and is separated from stored objects in such storage tank. Also at the same time, the CCD camera can be used for monitoring the current condition of the stored objects stored in the storage tank and/or recording reaction processes.

The device for gauging levels of stored objects capable of achieving the foregoing objects comprises two laser emitters for emitting laser beams onto the stored objects so as to form two laser dots thereon, a CCD camera for identifying image signals formed by the laser dots and/or monitoring any variations caused by the stored objects, and a timer circuit for calculating the time differences between the image signals caused by the two laser dots.

The stored objects can be all kinds of liquid such as petroleum, or powder particle such as soybean powder.

The laser emitter can be a laser pointer.

The CCD camera and the laser emitters can be disposed on an identical base.

The device for gauging levels of stored objects further comprises floating reflectors floating on the liquid surface such that the laser emitters may cause laser dots on such liquid surface.

Both ends of the floating reflectors may be coupled with a vertical wire or vertical rod respectively.

The ends of both vertical wire and vertical rod can be respectively coupled with a counterweight.

The vertical wires and counterweights are for keeping parallel the surfaces of the floating reflectors and the surface of the stored objects.

A transparent divider can be disposed between the gauging device and the storage tank.

The transparent divider can be strengthened glass.

The device for gauging levels of stored objects can be disposed inside a light-blocking mask.

The timer circuit further comprises a plurality of logic gates, a time counter, a plurality of triggers, a scan line timer and a microprocessor.

The plurality of logic gates are for confirming whether dot signals are located in the scan area.

The time counter is for calculating the time differences between two laser dots.

The plurality of triggers is for actuating or interrupting the timer counter.

The scan line timer is for counting the number of scan lines and transmitting interrupting signals to the microprocessor according to the counting results.

The microprocessor is for running interruption programs according to interrupting signals and for comparing and converting scan data.

The device for gauging levels of stored objects gauges the level of liquids or powders by utilizing lasers, not the variation or intensity of the reflective light, and the actual levels are calculated by using the distance between the two laser dots on the images of stored objects. The method of the present invention for converting distance into time can directly acquire the interval between the two projected dots via image signals, and then calculate the real level of the stored objects. In addition, no expensive digital signal processors (DSP) are needed for the device of the present invention for gauging levels of stored objects to process image identification, such that random access memories and cost could be saved and the security and convenience of gauging levels of stored objects improved. Further, the device of the present invention for gauging levels of stored objects reduces the reaction time of gauging, by reaching 1/60 seconds per level gauging process, a result that cannot be achieved by the conventional image identification method.

### BRIEF DESCRIPTION OF THE DRAWINGS

These and other features, aspects and advantages of the present invention will become better understood with regard to the following description, appended claims and accompanying drawings that are provided only for further elaboration without limiting or restricting the present invention, where:

FIG. 1 shows a graph for elaborating on principles of a device of the present invention for gauging levels of stored objects;

FIG. 2 shows a framework view for embodiment of a device of the present invention for gauging levels of stored objects disposed with floating reflectors;

FIG. 3 shows a schematic diagram of the scan area of a CCD camera;

FIG. 4 shows a schematic diagram for embodiment of level gauging process by a device of the present invention for gauging levels of stored objects;

FIGS. 5A and 5B show the distance of dots in the scan area;

FIG. 6 shows a sequence diagram of the R output signals and horizontal blocking signals of the CCD camera;

FIG. 7 shows a framework view for embodiment of verification circuit for dot signals;

FIG. 8 shows a sequence diagram of RP output signals;

FIG. 9 shows an amplified schematic diagram of the scan area and projected dots by the CCD camera;

FIG. 10 shows a sequence diagram of the RP signals from scan line S and scan line Q in FIG. 9;

FIG. 11 shows a framework view for an embodiment of the timer circuit;

FIG. 12 shows a sequence diagram of control signals from the scan line counter; and

FIG. 13 shows a sequence diagram of control signals from the timer circuit.

### DETAILED DESCRIPTION OF THE PREFERRED EMBODIMENT

The following is a detailed description of the best presently known modes of carrying out the inventions. This description is not to be taken in a limiting sense, but is made merely for the purpose of illustrating the general principles of the inventions.

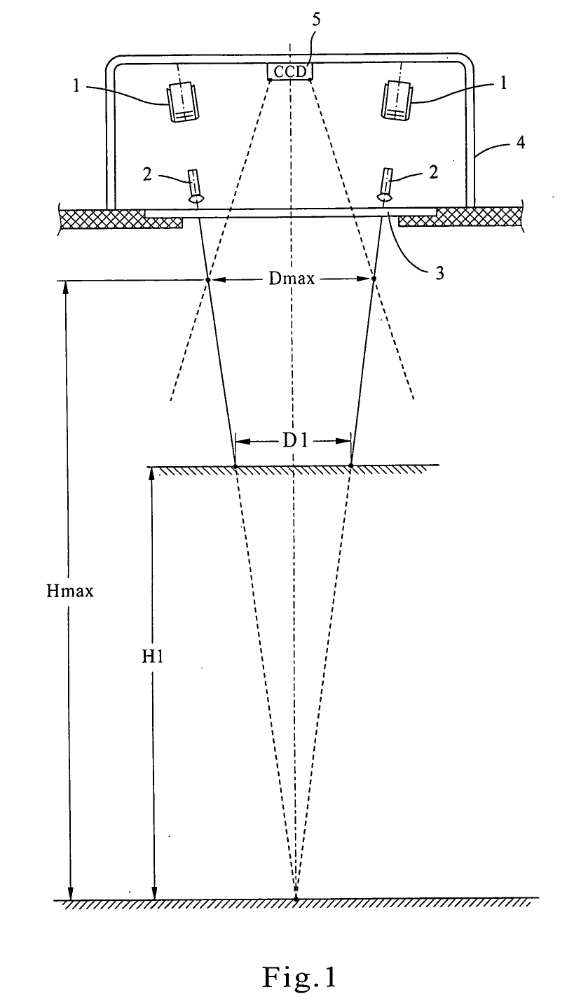

Please refer to FIG. 1 wherein a graph for elaborating on principles of a device of the present invention for gauging levels of stored objects is provided, whereby, as shown in FIG. 1, two laser emitters 2 (such as common laser pointers) providing low-power visible light (red light) are mounted on the base of an identical vertical surface, and the angle formed by the laser emitters 2 are simultaneously adjusted such that laser dots are projected on the identical spot at the bottommost position (at the bottom of the tank), thus forming the only projecting dot that falls onto a portion of scan lines of the image signals provided by the CCD camera. The width Dmax represents the horizontal distance between the two projecting dots when located at the level Hmax of the tank, whereas D1 represents the horizontal distance between the two projecting dots when located at the level H1 in the tank.

As the level of the stored object reaches H1, two dots are projected and both fall on the identical vertical surface. Therefore the image signals of the two dots, at the level H1 and level Hmax, shall be located in the identical scan area, making it even easier to identify such image signals of the two dots. The two laser beams are combined to form an isosceles triangle, causing the level gauged and the distance between the two laser dots to be correlated in linear ratios. Thus, as shown in FIG. 1, a formula can be obtained as follows:

H1/D1=Hmax/Dmax=K,

wherein K represents the coefficient for distance gauged.

Therefore, as long as a maximum level Hmax is predetermined and the horizontal distance is obtained, the present invention may only calculate the value of the horizontal distance D1, and then D1 is put into the formula of H1=K×D1, such that the actual level of the stored object in the tank can be obtained.

Since the object stored in either tank or container is identical, such as liquids like petroleum or edible oil or various powder particles like soybean powder or rice kernels, the difference of brightness for the dots projected on the stored object is extremely small. In addition, considering that the lighting in the tank is extremely gloomy already, a light-blocking mask 4 can further be mounted to avoid any intrusion of outside lighting. Consequently it is simple for the CCD camera 5 to identify the image signals of the two projected dots. If the user desires to observe the condition in the storage tank, such as the internal state of a fermentor or a chemical reactor, the CCD camera 5 can be utilized for observation. Therefore, two projectors 1 can also be mounted on the light-blocking mask 4 to provide the lighting for internal observation. Further, since the stored object in the storage tanks is not altered, as soon as the critical value of the degree of brightness for the image signals is switched, the level of the object stored in the storage tank can be accurately gauged. The present invention is not only applicable to stored objects that are not capable of being lit with light under long period of time, but also capable of gauging the level of the stored object as well as observing any adverse alteration inside the tank.

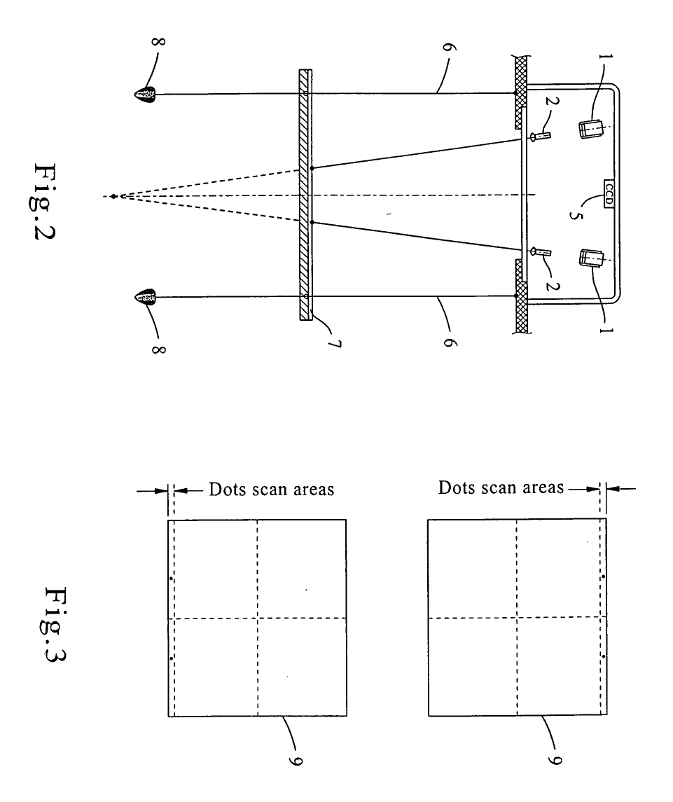

If the stored object is in the form of liquid such as petroleum, since such liquid is transparent, it will render the two laser emitter 2 difficult to form laser dots on top of the liquid surface. Thus floating reflectors can be disposed on top of the liquid surface. Please refer to FIG. 2, which shows a framework view for embodiment of the device of the present invention for gauging levels of stored objects disposed with floating reflectors, wherein two vertical wires 6 (or two vertical rods) attached respectively with a counterweight 8 are disposed in the storage tank, and a floating reflector 7 is perpendicularly incorporated thereto, such that the floating reflector 7 may not only float up and down along the vertical wires 6 in accordance with various levels reached by the liquid or powder particle surface, but also enable the projected light source to cause apparent projected dots onto any stored object (transparent or not), thus rendering images obtained by the CCDD camera clearer. Since the laser emitters 2 and the CCD camera 5 are all fixated on the identical vertical base, laser dots projected shall fall into the same scan area, therefore the user may clearly observe the condition inside the storage tank with the floating reflector 7 being in rectangular shape without having huge reflecting area.

Please refer to FIG. 3 in accordance with FIG. 1 and FIG. 2, which shows a schematic diagram of the scan area of a CCD camera, wherein the angle of the CCD camera 5 can be adjusted such that the dots projected are located in the scan areas at the topmost or bottommost of the screen 9, thus when the user observes the condition inside the storage tank, the screen shall not be affected by the dots.

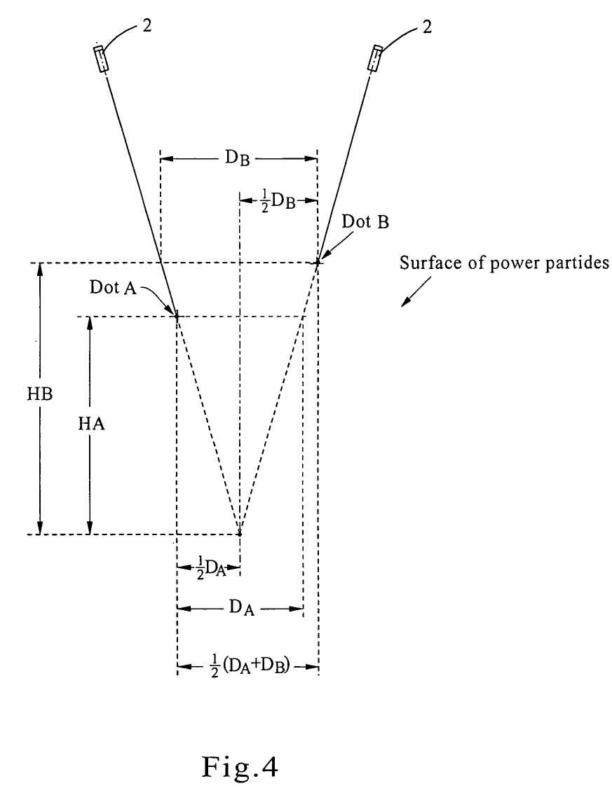

Please refer to FIG. 4, which shows a schematic diagram for embodiment of level gauging process by the device of the present invention for gauging levels of stored objects. If the stored object gauged is in the form of powder particles, a biased top surface might be caused after being stacked due to the nature thereof, as shown by the level difference between the level HA represented by the dot A and the level HB represented by the dot B. The device of the present invention, as calculating the distance between dot A and dot B, may then provide the result of ½ (DA+DB), which refers that the actual level shall be ½ (DA+DB)×k=½ (HA+HB). An average value of the level for the top surface of powder particles can be directly obtained through this method without being necessary to do any further calculations.

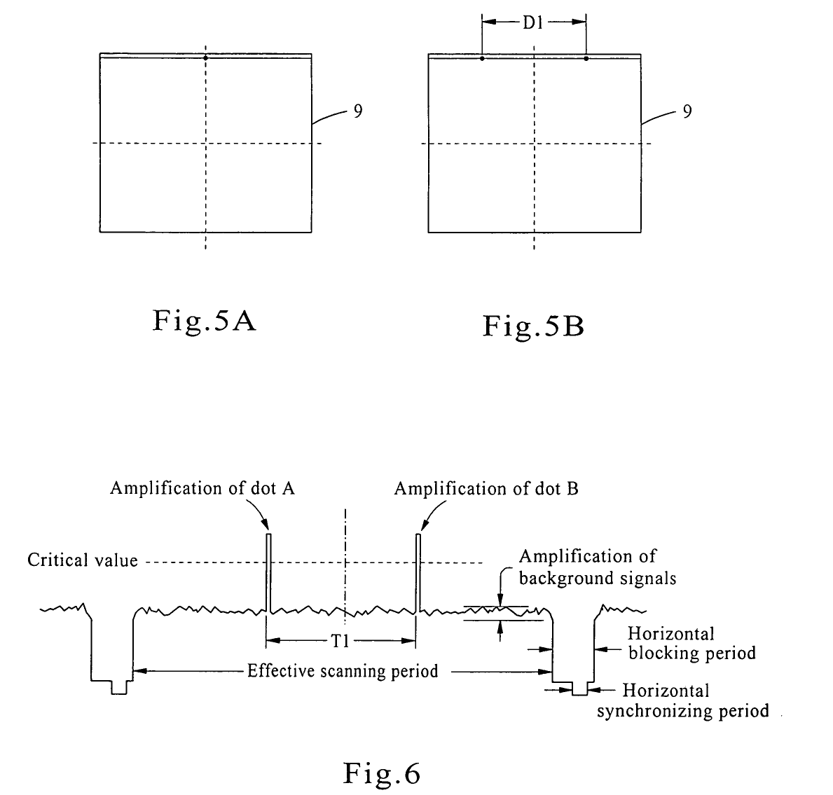

No expensive digital signal processors (DSP) are needed for the device of the present invention for gauging levels of stored objects to process image identification, instead only simple voltage comparators are needed for identifying the locations of the dot A and the dot B in the image signals. In addition, the level of the stored object inside the storage tank can be obtained by using the distance between dots on the screen 9 via the formula of H1=k×D1, as shown in FIGS. 5A and 5B, wherein a single dot represents the bottommost position, whereas two dots represent the level H1.

Images collected by the CDD camera are extremely simple, with the images obtained being surfaces formed by the same stored object, thus even though the stored object is wobbled, such as liquid being wobbled to form undulated surfaces or powder particles being wobbled to form biased surfaces, the average level of the stored object can still be obtained.

Please refer to FIG. 6, which shows a sequential view of the R output signals and horizontal blocking signals of the CCD camera. As shown in FIG. 6, under the state of identical lighting inside the storage tank, if the floating reflector 7 is utilized, the red dots shall be particularly apparent, thus the device of the present invention utilizes the R output signal in the RGB trichromatic output signals from the CCD camera as the input signal for the voltage comparator, so as to compare with the critical value. The critical value equals to the sum of the average value of the background signal (background brightness) obtained by R being outputted through a low-pass filter 10 and the quantity of compensation (quantity of lighting required by the stored object). The device of the present invention may automatically adjust levels according to the amplification of the background signals and provide different compensation quantity corresponding to different objects stored.

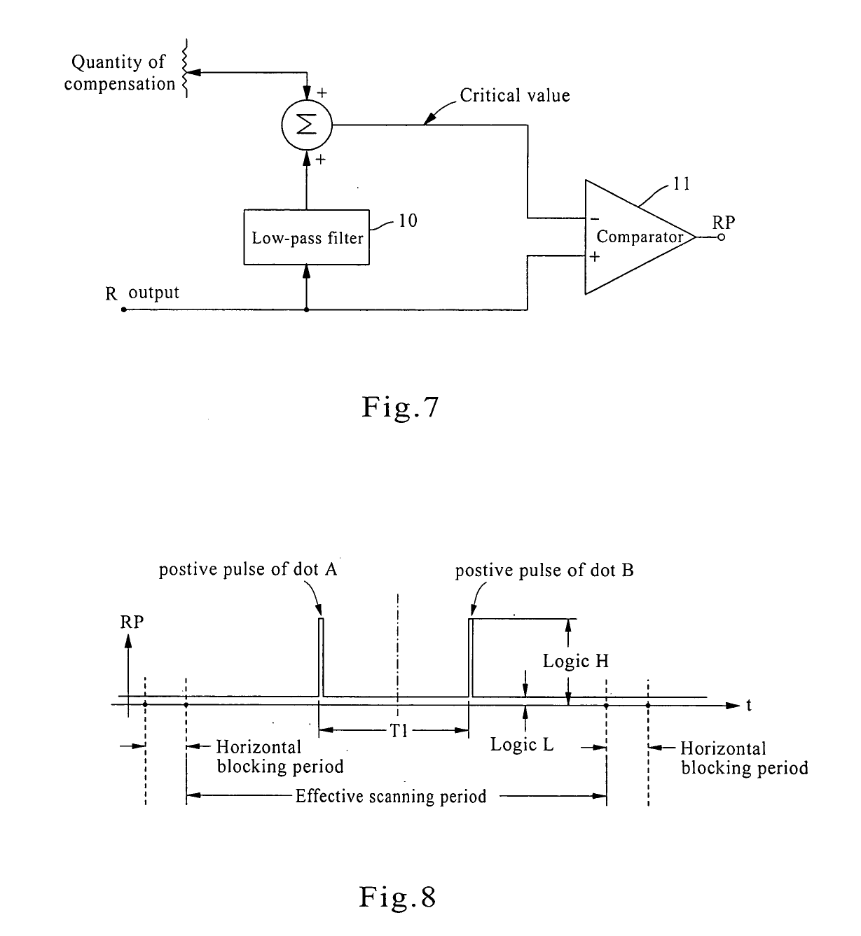

Please refer to FIG. 7 and FIG. 8 in accordance with FIG. 6, which show a framework view for embodiment of verification circuit for dot signals and a sequential view of RP output signals. As shown in FIG. 7, dot signal verification circuit is a simple circuit structure capable of obtaining the two positive pulse signal RP of the time difference T1. As shown in FIG. 8, the period of T1 represents the distance between dot A and dot B. The device of the present invention is thus capable of improving the gauging resolution via the time-counting means.

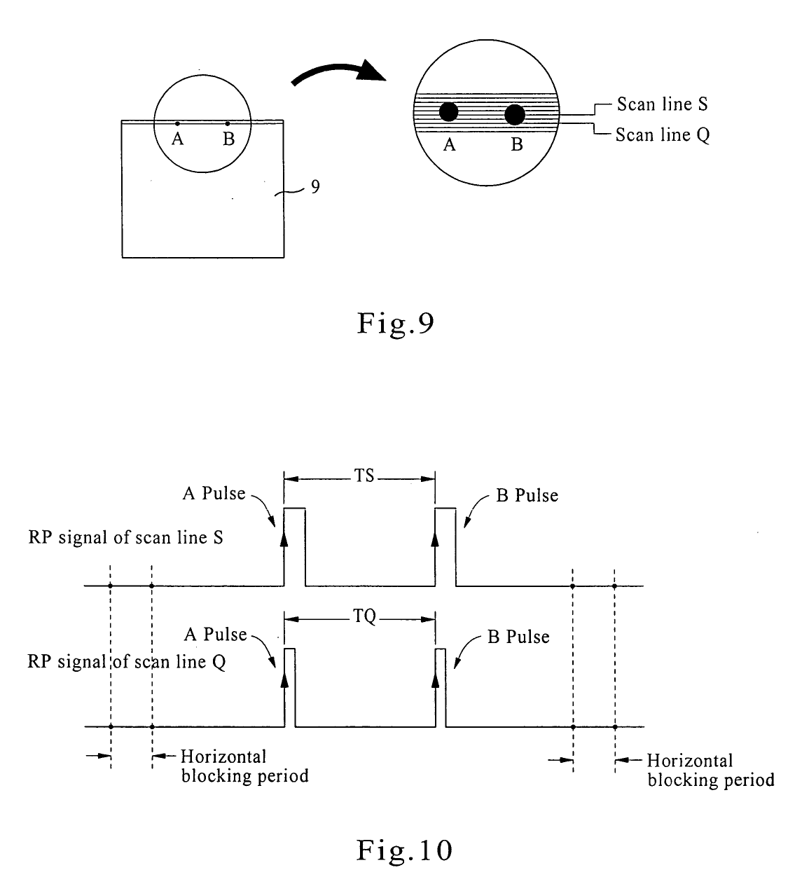

Please refer to FIG. 9, which shows an amplified schematic diagram of the scan area and projected dots by the CCD camera. As shown in FIG. 9, the factor of focusing enables the area of dots projected by laser beams to be enlarged according to the increase of distances,but the CCD camera provides the function that causes the image to be smaller as the object becomes farther away. Consequently, Irregular reflections caused by liquids being wobbled or powder particles being rolled may cause alterations of the dot areas. Therefore dot images are to appear not just on the only scan line, but in the area formed by a plurality of scan lines.

Please refer to FIG. 10 in accordance with FIG. 9, which shows a sequence diagram of the RP signals from scan line S and scan line Q in FIG. 9. As shown in FIG. 10, the time intervals corresponding to RP signals produced on different scan lines are not altered, thus more scan lines can be utilized for comparing the gauging data so as to obtain accurate results. Consequently the size of the dot areas shall not affect the gauging accuracy provided by the device of the present invention.

Common image identification systems employ pixels as units for calculating distances. For example, for National Television Standard Committee (NTSC), the highest frequency for video signals is 6 MHz, and the horizontal scan frequency is 15750 Hz, with the effective scan period for horizontal scan being 53.9 μs, such that if 646.8 pixels are provided, only 323.4 calibrates for distance can be divided into. Therefore, if 50 MHz pulses are used for the clock of a timer, 2695 timing values can be obtained, whereby 1347.5 calibrates for distance can be divided into. Thus the value of T1 is to represent D1, which can immediately be converted, or looked up in tables, so as to acquire the level of H1.

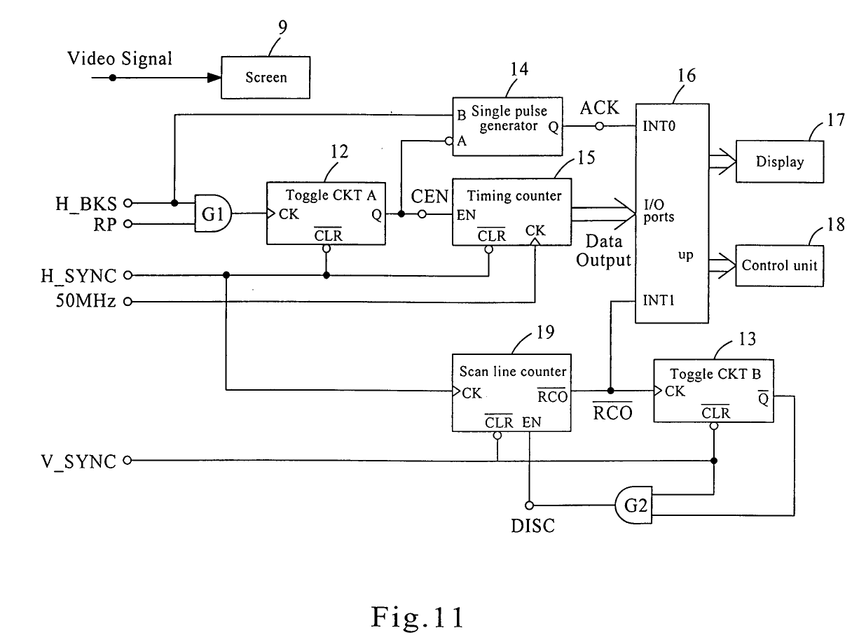

Please refer to FIG. 11 in accordance with FIG. 8, which shows a framework view for an embodiment of the timer circuit. As shown in FIG. 11, the timer circuit of the present invention utilizes the horizontal blocking signal H_BKS from the CCD camera 5 as the gate control signal for the timing system, and the horizontal synchronizing signal H_SYNC as the clear-up signal for the timer and the trigger 12 (Toggle CKT_A). The logic gate G1 is used for identifying whether dot signals fall into the effective scanning periods. As the front end of the positive pulse of dot A triggers the Toggle CKT_A, the output CEN=1 of the trigger 12 (Toggle CKT_A) is predetermined, such that the counter 15 for counting time is enabled to begin counting calculation with 50 MHz pulses having 20 ns as the timing unit. While the front end of the positive pulse of dot B triggers again the Toggle CKT_A and thus reverses the output thereof, the Toggle CKT_A is re-placed and CEN=0 is caused, and the counter 15 is then disabled and ceases the counting process immediately, with the single pulse generator 14 being then triggered to transmit ACK signals, such that the ACK signals are used as the INT Φ signal for requesting the microprocessor 16 to interrupt. After the microprocessor 16 interrupts running the minor programs, the counting value T1 of the horizontal scan period is read, and such T1 represents the gauging level H1. The time-counting means is employed in the present invention for replacing the conventional means of using the number of pixels to measure distances of dots such that the gauging resolution can further be improved.

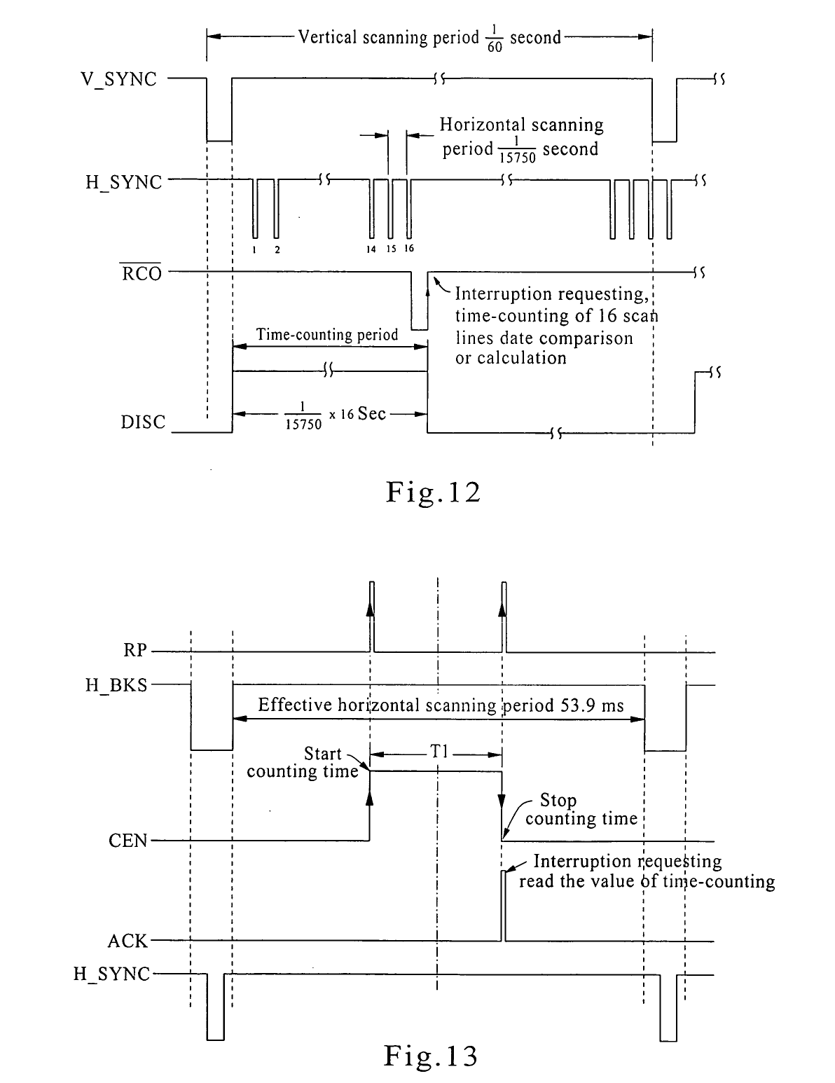

Please refer to FIG. 12 and FIG. 13, whereby a sequence diagram of control signals from the scan line counter and a sequence diagram of control signals from the timer circuit are respectively shown. In one of the preferred embodiments of the present invention, angles of the CCD camera 5 can be adjusted such that dots fall at the topmost portion of the screen. For example, if the distance amounts to 10 meters, all dots would fall in the scan area formed by the topmost sixteen scan lines, thus a scan line counter 19 can be added with a vertical synchronizing signal V_SYNC as a clear-up signal and a horizontal synchronizing signal H_SYNC as a time pulse. The total time periods of the sixteen scan lines are used for searching for time-counting data, with the rest thereof being used by the microprocessor 16 for data comparison or calculation, such that a level gauging process can be completed during each vertical scan period (within 1/60 second).

Further, during each time-counting period, as the sixteenth scan line is being counted, the scan line counter 19 is to transmit interruption requesting signal INT1 to the microprocessor 16, such that the microprocessor is to interrupt the minor program, compare the counting data obtained by counting each scan line and convert such to actual levels.

As the blocking period is entered, when the horizontal synchronizing signal H_SYNC equals to zero, the counter 15 for counting time is to be cleared to 0, and the Toggle CKT_A is re-placed and CEN=0 is caused, thus the time-counting process against the next scan line can be reset to 0. If only one dot is projected, it refers to the condition that the level of the stored objects is located at the bottommost in the storage tank such that ACK signals cannot be obtained during effective scan periods, therefore the microprocessor 16 would indicate the designated time as zero, meaning the level of the stored object is at the bottommost position and the level is zero.

In the other preferred embodiment of the present invention, the height of the storage tank is set to be five meters. The time-counting time pulse of 50 MHz enables the gauging resolution to be 0.0037 meter, whereas the gauging resolution may reach 0.00148 meters if the height of the storage tank is two meters.

The time-counting means used by the device of the present invention enables the user to obtain the time T1 of the two dot signals, and further convert such to D1 thus obtaining the level H1 via calculation or looking into conversion tables. Further, the device of the present invention may employ a time-counting time pulse with higher frequencies, such as 100 MHz, which can easily be accomplished according to frequencies current ICs may operate, thereby a result that further improves the gauging resolution is obtained. Yet in view of the device of the present invention, it is more than sufficient for gauging levels of stored objects in storage tanks, since the device of the present invention, by using 50 MHz as the time-counting time pulse, may cause the resolution obtained by using the number of pixels to measure distances between dots to be four times higher than that obtained via conventional means.

Although the present invention has been described in considerable detail with reference to certain preferred embodiments thereof, those skilled in the art can easily understand that all kinds of alterations and changes can be made within the spirit and scope of the appended claims. Therefore, the spirit and scope of the appended claims should not be limited to the description of the preferred embodiments contained herein.

What is claimed is:

1. A device for gauging levels of stored objects, comprising:
two laser emitters for projecting laser light sources onto a stored object and forming two laser dots;
a CCD camera for identifying image signals of said laser dots and/or monitoring any alteration of said stored object; and
a timer circuit for calculating time interval between said image signals of said laser dots.

2. The device for gauging levels of stored objects as in claim 1, wherein said stored object can be in the form of liquid or powder particle.

3. The device for gauging levels of stored objects as in claim 1, wherein said laser emitters can be laser pointers.

4. The device for gauging levels of stored objects as in claim 1, wherein said CCD camera and said laser emitters are mounted on an identical base.

5. The device for gauging levels of stored objects as in claim 1, wherein said device for gauging levels of stored objects can further comprise floating reflectors that float on the surface of said stored object such that said laser light sources may cause laser dots thereon.

6. The device for gauging levels of stored objects as in claim 5, wherein both ends of said floating reflectors can be incorporated respectively with a vertical wire or a vertical rod, such that said floating reflectors can be parallel to said stored object.

7. The device for gauging levels of stored objects as in claim 6, wherein the other end of either said vertical wire or said vertical rod can be incorporated with a counterweight.

8. The device for gauging levels of stored objects as in claim 1, wherein a transparent divider can be disposed between said device for gauging levels of stored objects and the storage tank.

9. The device for gauging levels of stored objects as in claim 8, wherein said transparent divider can be a piece of strengthened glass.

10. The device for gauging levels of stored objects as in claim 1, wherein said device for gauging levels of stored objects can be mounted within a light-blocking mask.

11. The device for gauging levels of stored objects as in claim 1, wherein said timer circuit further comprises a plurality of logic gates, timing counter, a plurality of triggers, a scan line timer and a microprocessor.

12. The device for gauging levels of stored objects as in claim 11, wherein said plurality of logic gates are for confirming whether dot signals are located in the scan area.

13. The device for gauging levels of stored objects as in claim 11, wherein said timer counter is for calculating the time interval between said two dot signals.

14. The device for gauging levels of stored objects as in claim 11, wherein said plurality of triggers are for actuating or interrupting said timer counter.

15. The device for gauging levels of stored objects as in claim 11, wherein said scan timer is for counting the number of scan lines and transmitting interrupting signals to said microprocessor according to the counting results.

16. The device for gauging levels of stored objects as in claim 11, wherein said microprocessor is for running interruption programs according to said interrupting signals and for comparing and converting scan data.
